(19) United States
(12) Patent Application Publication
(10) Pub. No.: US 2023/0112482 A1
(43) Pub. Date: Apr. 13, 2023

(54) SYSTEM AND METHOD FOR MANAGING COMMUNICATION NETWORKS WITH QUANTUM BLOCKCHAINS

(71) Applicants: AT&T Intellectual Property I, L.P., Atlanta, GA (US); AT&T Mobility II LLC, Atlanta, GA (US)

(72) Inventors: Mark Stockert, San Antonio, TX (US); Thomas J. Routt, Sequim, WA (US)

(73) Assignees: AT&T Intellectual Property I, L.P., Atlanta, GA (US); AT&T Mobility II LLC, Atlanta, GA (US)

(21) Appl. No.: 17/498,229

(22) Filed: Oct. 11, 2021

(51) Int. Cl. G06F 16/23; H04W 48/02; G06Q 50/18; G06N 10/00; G06N 20/00; H04L 9/32

(52) U.S. Cl. CPC G06F 16/2372; H04W 48/02; G06Q 50/18; G06N 10/00; G06N 20/00; H04L 9/3247

(57) ABSTRACT

Aspects of the subject disclosure may include, for example, a method of receiving, by a processing system including a quantum processor or a hybrid quantum-classical processor, proposed contract data representative of a proposed contract for access by an application of a user equipment to resources of a network slice usable for the access by the application; based on the proposed contract data, storing, by the processing system, governing contract data representative of a governing contract in a quantum blockchain ledger, wherein storing the governing contract data comprises facilitating an appending of an information block corresponding to the governing contract data to the quantum blockchain ledger, and wherein the governing contract is selected to control the access by the application to the resources of the network slice; detecting, by the processing system, a condition of the access that is not encompassed by the governing contract, resulting in a detected condition; and based on the detected condition, terminating, by the processing system, the access to the resources of the network slice by the application. Other embodiments are disclosed.

### FIELD OF THE DISCLOSURE

The subject disclosure relates to a system and method for managing communication networks with quantum blockchains.

### BACKGROUND

Machine learning (ML) is a hybrid branch of Artificial Intelligence (AI) and statistics that generally refers to patterns that are derived (‘learned’) from input data, in which machines learn, perform, and improve their operations by exploiting data-informed knowledge. Classical (non-quantum) machine learning (CIVIL) is used to a great extent to categorize data instances into classes that are either user-defined or derived from the intrinsic structure of data. CIVIL can be utilized for example, to power big data analytics to realize predictive/prescriptive, proactively optimized, self-sustaining public safety mobile networks. See U.S. Pat. Nos. 10,244,581; 10,660,157; 10,827,561 and U.S. Pat. Pub. No. 2021/0022211, entitled “Public Safety Analytics Gateway.”

CML algorithms are generally distinguished into supervised, unsupervised, and Reinforced Learning (RL) categories. Supervised classical learning utilizes pre-defined sets of training data (labeled datasets) containing data points previously interrogated, to produce a set of classifications where the CIVIL algorithm optimizes internal parameters until close classification of the training set has been attained.

Unsupervised classical learning invokes a clustering algorithm (i.e., k-means) which can split input data into distinct clusters for later classification. RL has no training set but instead inputs data classification results into an unmarked dataset as either correct or incorrect, which is then iterated through the algorithm, resulting in a learning process.

CML is traditionally directed to classical (non-quantum) data sources but will be increasingly required to operate on data originating from quantum computational sources, a requirement that inexorably generates intractable runtimes due to exceeding polynomial time calculation thresholds against quantum computational data sources, because classical computation processing performs tasks in a serial fashion.

In contrast, quantum computation pursues all computational trajectories simultaneously based on quantum superposition. Quantum computation stores information as quantum bits (qubits) which are quantum generalizations of classical bits. Qubits can be represented as a 2ⁿ level quantum system based on, for example, electronic/photonic spin and polarization, where:
The state of a qubit is a phase vector |ψ [symbol] (mathematical description of a quantum system, a complex-valued probability amplitude and the probabilities for possible results of measurements made on the system) in a linear superposition of states such as |ψ [symbol] =α|0 [symbol] +β|1 [symbol] ;
State vectors |0 [symbol] and |1 [symbol] are physical eigenstates of the logical observable, and form a computational basis spanning a two-to-n dimensional Hilbert space (inner product space of two or more vectors, equal to the vector inner product between two or more matrix representations of those vectors) containing |ψ [symbol] ;
And where a collection of qubits comprises a multi-particle quantum system.

Quantum logic gates form basic quantum circuits that operate on qubits, and unlike classical logic gates, are reversible (with a few exceptions). Quantum logic gates are unitary operators, described as unitary matrices relative to basis states. Quantum algorithms utilize quantum circuit gates to manipulate states of quantum systems just as classical algorithms utilize classical logical gates (represented as a sequence of Boolean gates) to perform classical (non-quantum) computational operations.

Fifth generation (5G) network slicing enables virtualization of network resources and network functions. 5G network slicing is defined in the 3^{rd} Generation Partnership Project (3GPP). Network slicing divides a physical network into virtual network segments. Current systems for 5G slice management cannot scale to meet the capacity, latency and QoS requirements of 6G networks. See, e.g., U.S. Pat. No. 10,965,777 and U.S. Pub. No. 2021/0168031, which are incorporated by reference herein.

The subject disclosure describes, among other things, illustrative embodiments for managing network slices and other network resources in a quantum-classical network using a quantum blockchain.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating representative ranges of 4G, 5G and projected 6G mobile spectrum deployed by a system, in accordance with various aspects described herein.

FIG. 2B is a block diagram illustrating a network system of Quantum Reinforcement Learning (QRL) agents that manage complexity, scalability, and optimizes resource usage, in accordance with various aspects described herein.

FIG. 2C is a block diagram illustrating an example, non-limiting embodiment of network quantum managers (QMs) functioning within the communication network in accordance with various aspects described herein.

FIG. 2D depicts a diagram that illustrates an example method of network connections and data exchanged between user equipment (UE), a node, a quantum blockchain ledger (QBL), and a provider, that can facilitate an application-based network slice request, in accordance with various aspects described herein.

FIG. 2E depicts a flow diagram that illustrates connections and example of data exchanged between a UE, a node, a QBL, and a provider, that can facilitate the expulsion of a UE app from an allocated network slice, in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for managing network slices and other network resources in a quantum-classical network using a quantum blockchain. Other embodiments are described in the subject disclosure.

One or more aspects of the subject disclosure include a device including a processing system including a processor; and a memory that stores executable instructions that, when executed by the processing system, facilitate performance of operations, the operations comprising: receiving proposed contract data representative of a proposed contract for access by an application of a user equipment to resources of a network slice usable for the access by the application; based on the proposed contract data, storing governing contract data representative of a governing contract in a quantum blockchain ledger, wherein storing the governing contract data comprises facilitating an appending of an information block corresponding to the governing contract data to the quantum blockchain ledger, and wherein the governing contract is selected to control the access by the application to the resources of the network slice; scheduling use of the resources of the network slice for the application based on the governing contract data; detecting a condition of the access that is not encompassed by the governing contract, resulting in a detected condition; and based on the detected condition, terminating the access to the resources of the network slice by the application.

One or more aspects of the subject disclosure include a non-transitory, machine-readable medium having executable instructions that, when executed by a processing system including a quantum processor or a hybrid quantum-classical processor, facilitate performance of operations, including: receiving proposed contract data representative of a proposed contract for access by an application of a user equipment to resources of a network slice usable for the access by the application; based on the proposed contract data, storing governing contract data representative of a governing contract in a quantum blockchain ledger, wherein storing the governing contract data comprises facilitating an appending of an information block corresponding to the governing contract data to the quantum blockchain ledger, and wherein the governing contract is selected to control the access by the application to the resources of the network slice; scheduling use of the resources of the network slice for the application based on the governing contract data; detecting a condition of the access that is not encompassed by the governing contract, resulting in a detected condition; and based on the detected condition, terminating the access to the resources of the network slice by the application.

One or more aspects of the subject disclosure include a method of receiving, by a processing system including a quantum processor or a hybrid quantum-classical processor, proposed contract data representative of a proposed contract for access by an application of a user equipment to resources of a network slice usable for the access by the application; based on the proposed contract data, storing, by the processing system, governing contract data representative of a governing contract in a quantum blockchain ledger, wherein storing the governing contract data comprises facilitating an appending of an information block corresponding to the governing contract data to the quantum blockchain ledger, and wherein the governing contract is selected to control the access by the application to the resources of the network slice; detecting, by the processing system, a condition of the access that is not encompassed by the governing contract, resulting in a detected condition; and based on the detected condition, terminating, by the processing system, the access to the resources of the network slice by the application.

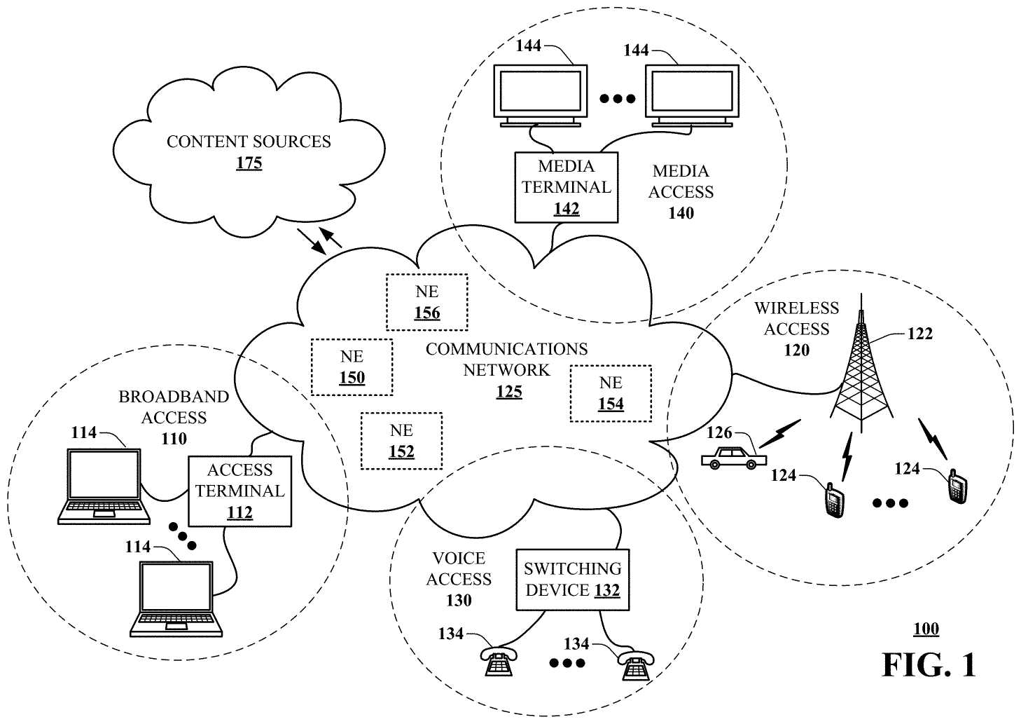

Referring now to FIG. 1, a block diagram is shown illustrating an example, non-limiting embodiment of a system 100 in accordance with various aspects described herein. For example, system 100 can facilitate in whole or in part receiving proposed contract data for access to resources of a network slice, storing governing contract data in a quantum blockchain ledger, scheduling use of the resources of the network slice for the application based on the governing contract data, detecting a condition of the access that is not encompassed by the governing contract, and terminating access to network slice resources. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, 6G or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

Rapid growth of wireless traffic is expected to exhaust the capacity of 5G networks in the next 5-10 years. 6G systems are expected to require a tenfold increase in capacity and a tenfold reduction (10 ms to 1 ms) in latency. 5G Dynamic slicing is the real-time allocation and de-allocation of network resources for a slice of the network based on priority, bandwidth and other factors. A 5G slice could be a channel, portion of a channel, several channels, or other combinations of network resources. Network operators dynamically slice 5G networks to allow secure and dedicated virtual networks for the optimized delivery of any service toward a wide range of users, vehicles, machines, and industries. It is an important element for management when a large number of users are connected to a large number of heterogeneous networks in 5G communication systems.

Mobile network technology evolution informs pre-standards for development of sixth generation (6G) standards in the International Telecommunication Union (ITU) international mobile technology (IMT), Standards Developing Organizations (SDOs), and third generation partnership project (3GPP). Requirements under consideration include on-demand topology; three-dimensional (3D) connectivity; integration of communications and sensing technologies; ultra-high-speed, high-capacity, low-latency connectivity; and on-demand artificial intelligence (AI). 6G mobile networks are projected to provide an increase of ˜100 times in volumetric spectral and energy efficiency (bps/Hz/m3) relative to fifth generation (5G) networks. 6G networks are projected to incorporate a massive connectivity-based structure.

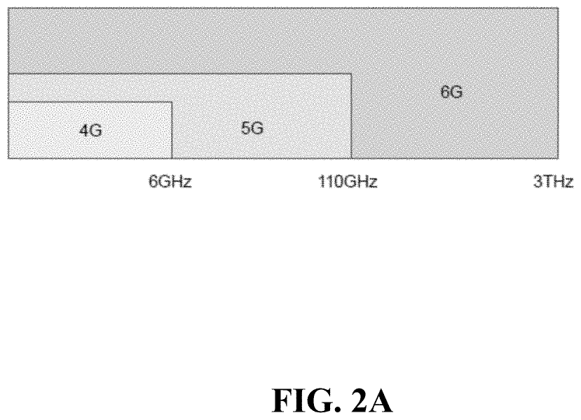

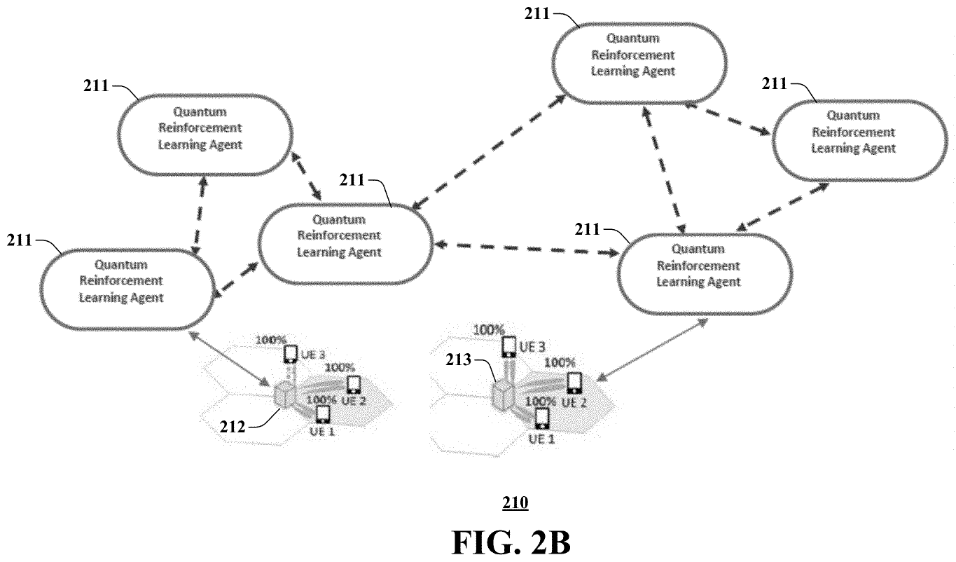

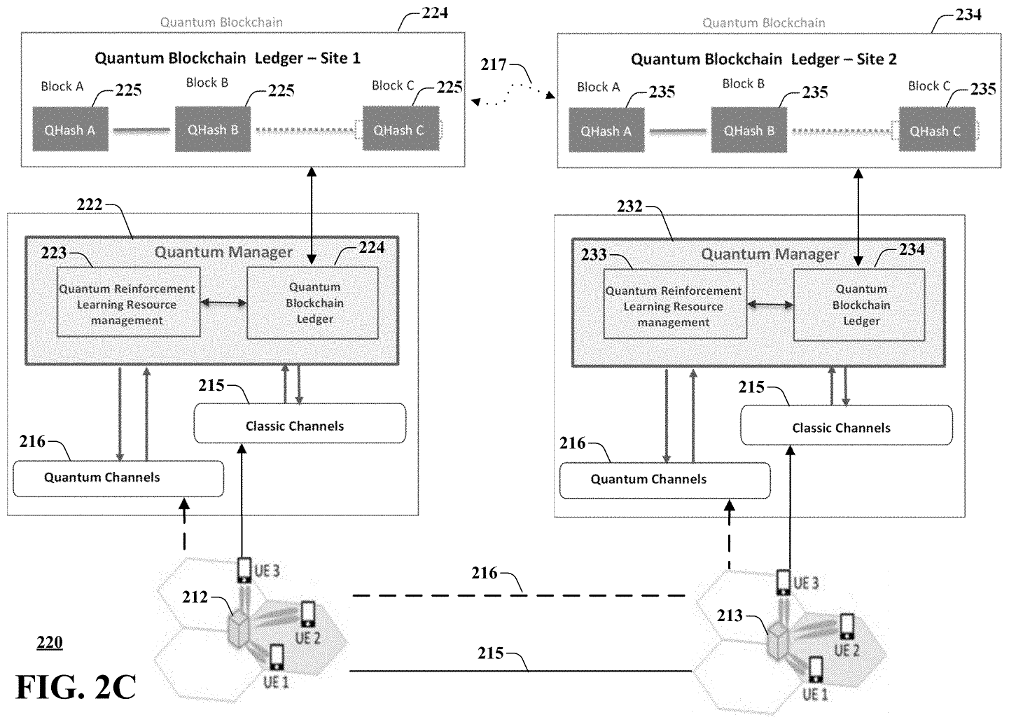

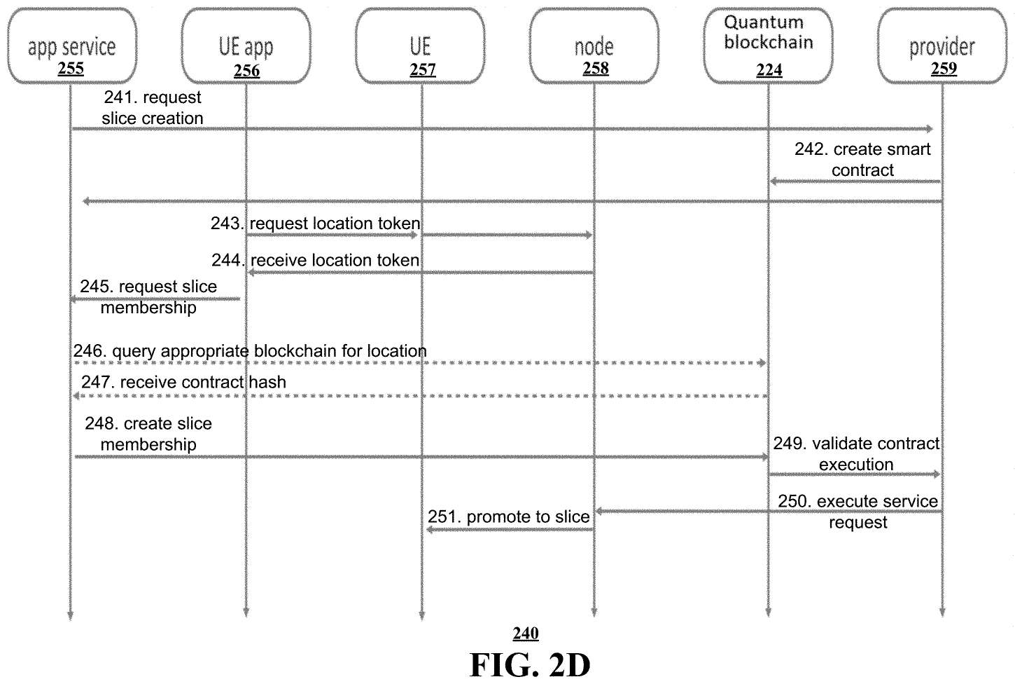

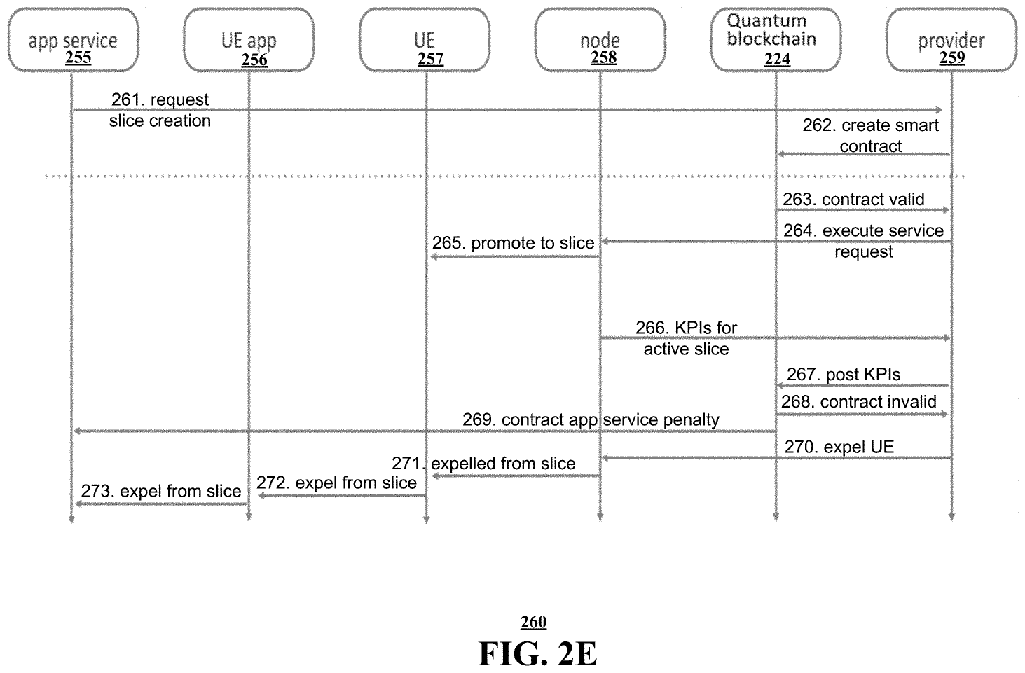

FIG. 2A is a block diagram illustrating representative ranges of 4G, 5G and projected 6G mobile spectrum deployed by a network, in accordance with various aspects described herein. As shown in FIG. 2A, ranges of 4G, 5G [sub-6 GHz (Sub6 mmW)], and projected 6G (>100 GHz-to-multi-THz)] mobile network spectra illustrate a requirement for 6G spectra to co-exist with 5G Sub6, 5G mmW, and 4G LTE bands/spectra.

6G networks are expected to be support a wide variety of services including on-demand topology; three-dimensional (3D) connectivity; integration of communications and sensing technologies; ultra-high-speed, high-capacity, low-latency connectivity; and on-demand artificial intelligence (AI) over a variety of network topologies (land, air, space, sea) based on a seamlessly integrated connectivity architecture. Many of these services will have stringent Quality of Service (QoS) requirements. Projected 6G systems will require much more stringent security and privacy requirements for network resource management, access, authentication and encryption. 6G systems also must be protected from network attacks and malicious behavior.

The exemplary embodiments presented herein are applicable not only to current network technologies, but also to projected 6G hybrid quantum/classical networks or future networking technologies. Projected 6G hybrid quantum/classical networks will be required to support resource isolation to guarantee that an attack on a resource will not affect any other network resources, to ensure that when an end device uses several resources at the same time it is not used as a bridge to move data from one resource to another, and to avoid the propagation of an attack when using shared resources and functions by the “cascade effect.” Intra-resource isolation presents another challenge in that it seeks to control the behavior of the components inside the network resource. This control can be implemented by running a quantum/classical virtual resource manager function to manage the desired isolation property.

Emerging quantum networks are based on quantum communication channels that transmit qubits between physically distinct quantum processors or hybrid quantum-classical processors that can perform quantum logic operations on qubits. Quantum networking solutions are assuming strategic importance due to continuing cost-performance improvements in classical (non-quantum) processor memory, speed, and VLSI substrate density packing are not sustainable due to quantum effects that pervade the quantum scales at which electronic and photonic processors, devices, and network components are fabricated and process data. 6G mobile networks increasingly require quantum and hybrid quantum-classical communications to interconnect a plurality of end-to-end (ETE) quantum and hybrid quantum-classical networked application resources, i.e., application programs, application programming interfaces (APIs), application servers, security servers, data repositories/lakes, routers, switches, load balancers, links, etc.

Quantum data generated by quantum and hybrid quantum-classical computational runtime environments are characterized by quantum superposition and quantum entanglement, and yield n-dimensional probability distributions that require exponential compute resources to process, represent, store, and connect. The presence of quantum/hybrid or quantum/classical ETE networked application resources in turn, exponentiates requirements to incorporate QAI, QML and Quantum Deep Learning (QDL) within 6G mobile and fixed communications networks.

Quantum Artificial Intelligence (QAI)-based Quantum Machine Learning (QML) can be run against pure quantum, pure classical, and/or hybrid quantum/classical computational runtime environments. QML has advantages over classical machine learning (CML) that include:
QML operates within a 2ⁿ-dimensional Hilbert space, an exponential computational resource not accessible by CIVIL;
Quantum computation provides a degree of parallelism not available in classical computation;
Data-driven learning coupled with quantum computing methods are uniquely positioned to realize a service-driven, fully intelligent mobile network environment;
QML achieves faster processing relative to CML derived in part from invocation for example, of Grover's quantum factoring, Shor's quantum search, or Routt's quantum search/quantum-classical cryptosystem algorithms. See Grover, L. “Quantum Mechanics Helps in Searching for a Needle in a Haystack,” Physical Review Letters, 79(2), 325 (1997); Shor, P. W., “Polynomial-Time Algorithms for Prime Factorization and Discrete Logarithms on a Quantum Computer,” SIAM Journal on Computing, 26(5), 1484 (1997); U.S. Pat. Nos. 7,451,292 and 8,190,553.

FIG. 2B is a block diagram illustrating a network system 210 of Quantum Reinforcement Learning (QRL) agents 211 that manage complexity, scalability, and optimizes resource usage, in accordance with various aspects described herein. As shown in FIG. 2B, QRL agents 211 are software/hardware entities that instantiate autonomous or semi-autonomous control functions into quantum, classical, and hybrid quantum-classical networks. The QRL agents 211 combine RL control elements with quantum network elements (i.e., quantum channels, quantum memory, quantum logic gates, etc.). Networked QRL agents 211 can be modeled in terms of control loops (local and global) with self-monitoring, self-adjustment, knowledge, and planner/adapters to apply to policies based on awareness of the distributed processing environment.

In an embodiment, network system 210 would learn, perform, and improve QRL operations by exploiting data-driven operational, tactical, and strategic knowledge and experience provided by quantum, hybrid quantum-classical, and classical computation platforms and runtime environments, within supervised, semi-supervised, unsupervised, deep learning, reinforcement learning and other machine learning architectures. Networked QRL agents 211 predict future mobility patterns, end device locations, device association, manage spectrum resources (i.e., channel quality, admission control, handover optimization, path loss, shadow fading), and optimize traffic (i.e., number of devices/elements per unit area). QRL agents 211 dynamically and prescriptively optimize for example, radio channel quality based on quantum superposition, quantum entanglement, and massively parallel multi-dimensional processing of radio identification, channel tracking, routing, and switching. Network system 210 provides quantum speedup for QRL agents 211 based on an environment paradigm utilizing quantum superposition and parallelism to identify eigenstates, where the probability of a given eigen action is determined by probability amplitudes that inform decision boundaries.

FIG. 2C is a block diagram illustrating an example, non-limiting embodiment of network quantum managers (QMs) functioning within the communication network 220 in accordance with various aspects described herein. As shown in FIG. 2C, network QMs 222, 232 incorporate QRL agents 223, 233 that manage network resources, access control and privacy, and use distributed quantum blockchain ledgers (QBLs) 224, 234 to manage the security and privacy of network resources for network nodes 212, 213 communicating classical digital information across classic channels 215 and quantum information across quantum channels 216. QMs 222, 232 can limit an attack on a network resource or other resources that are individually identified and managed with separate blocks 225, 235 on distributed QBLs 224, 234.

A distributed QBL 224, 234 is a quantum computational decentralized, encrypted, distributed database. In a classical blockchain, communication and trust between nodes relies on digital signal technology. Security of classical digital signal technology assumes that computational complexity for certain mathematical problems is sufficient such that those problems (proof of work) cannot be readily solved within polynomial (tractable) time. Development of quantum computation and quantum algorithms poses a serious risk to classical (non-quantum) blockchain technology. For example, Shor's quantum search algorithm can solve integer factorization in polynomial time. Quantum computers can solve some non-deterministic (NP)-hard problems (i.e., subset sum problem, traveling salesman problem, Boolean satisfiability problem, halting problem) more rapidly than classical computers.

QBLs 224, 234 are a combination of quantum technology and blockchain technology. The main advantages of a quantum blockchain are security and efficiency. Security between quantum blockchain nodes is guaranteed by the properties of quantum physics. Distributed QBLs 224, 234 are connected via quantum entanglement 217 where the quantum state of participating particles in the group cannot be described independently of the state of the others, providing a foundation for effective modification resistance. The efficiency of QBLs 224, 234 is based on faster processing speeds for quantum technology. In addition, a quantum digital signature (QDS) can be used to verify the owner of a network resource. A QDS is the quantum equivalent of a digital signature with asymmetric keys. A QDS can use either a public quantum-bit key with a private classical bit string or a private quantum bit string.

In an embodiment, QMs 222, 232 provide massively parallel QBLs, QRL agents and QML architectures across a plurality of time, space, and frequency domains. QMs 222, 232 securely manage quantum memory, quantum channels/slices, qubits, and hybrid quantum/classical channels/slices for the network.

In an embodiment, QMs 222, 232 manage electromagnetic, opto-electronic and/or optical signatures stored in QBLs 224, 234 as a method of authentication.

In an embodiment, QMs 222, 232 learn and improve QML decentralized access and security by making intelligent decisions at multiple levels for distributed QML/QAI datasets and content (i.e., images, text, audio, video, code, etc.).

In an embodiment, QMs 222, 232 manage spectrum encryption and coding schemes to enhance the security of resources, i.e., admission control, network/channel slicing and allocation.

In an embodiment, QMs 222, 232 manage quantum Quality of Service (QoS) analogous to bits per second in classical networks.

In an embodiment, QMs 222, 232 manage quantum QoS Priority and Preemption (QPP) analogous to prioritized access and non-preemption once connected within classical network environments.

In an embodiment, QMs 222, 232 manage Software Defined Network (SDN) Virtualized Network Element (VNE) allocation, distribution, and versioning.

In an embodiment, QMs 222, 232 manage massive IoT resources, workload distribution, and offloading to mobile edge computing (MEC) via secure authorization. QMs 222, 232 manage smart factory, MEC resources, workload distribution and offloading to distributed elements via secure authorization.

In an embodiment, QMs 222, 232 manage detection, alerting and prevention of eavesdropping, intrusion and malicious behavior.

In an embodiment, QMs 222, 232 securely manage direct communications for ubiquitous first responder/emergency services including secure content caching and content sharing.

In an embodiment, QMs 222, 232 would securely manage resources for autonomous drone networks and autonomous vehicle systems.

In an embodiment, QMs 222, 232 securely manage network devices, node location and privacy.

In an embodiment, QMs 222, 232 securely manage Smartdust computing resources and authorization, where a system of multiple micro-electromechanical system (MEMS) such as sensors and robots, that can detect vibration, light, temperature, magnetism, chemicals.

In an embodiment, QMs 222, 232 securely manage the control and tracking of records for medical equipment, devices, medications drugs, devices, etc., to include where they are located and who accessed them (i.e., hospital, campus, medical complex, physician's office, ambulance, etc).

In an embodiment, QMs 222, 232 provide an audit trail of software/hardware upgrades, resource calibration, resource testing, etc. (i.e., where and when performed, by whom).

In an embodiment, QMs 222, 232 provide frictionless shopping. Quantum accuracy applied to shopping, could track items placed in a cart and generate financial transaction upon leaving a commercial establishment, store, etc. without requiring checkout and lines/queues (i.e., grab-and-go). Electronic, optical, or opto-electronic receipts, recorded in QBLs 224, 234 are stored and/or referenced at any time.

In an embodiment, QMs 222, 232 provide private, personal health records that can only be shared/viewed in a medical office, hospital, or by a health care provider. The records are stored on a primary device or devices and access is limited by the owner. A geofence around the devices/persons/owners limits record sharing within a designated range (i.e., personal space, home, office, etc.).

In an embodiment, QMs 222, 232 support time and location-based transactions, i.e., car parking, bus passes, train passes, aircraft boarding passes, leasing, ship boarding, etc.

In an embodiment, QMs 222, 232 provide a record and validation of work (maintenance, new, etc.) based on location and time.

In an embodiment, QMs 222, 232 facilitate payment for commercial transactions including machines, vehicles, etc. repair. QMs 222, 232 keep an immutable record of work and payment that cannot be altered or changed in QBLs 224, 234.

In an embodiment, QBL 224, 234 records provide a plurality of analytic datasets to include for example, mean time to repair, best time to replace, reliability records, etc.

In an embodiment, QMs 222, 232 facilitate rapid addition and deployment of new individuals within known organizations and previously unknown organizations to an affected disaster area. QMs 222, 232 manage provenance of data for use within disaster areas.

FIG. 2D depicts a diagram that illustrates an example method 240 of network connections and data exchanged between UE 257, node 258, QBL 224, and provider 259, that can facilitate an application-based network slice request (e.g., by app service 255 of UE app 256), in accordance with one or more embodiments. For purposes of brevity, description of like elements and/or processes employed in other embodiments is omitted.

At step 241, app service 255 issues a request to have resources of a network slice allocated for the use of the app service of UE app 256. In one or more embodiments the generated request can include proposed agreement data representative of a proposed agreement applicable to access resources of a network slice. Additionally, one or more embodiments can involve execution of the application service on the UE 257, whereas in one or more additional or alternative embodiments, app service 255 can be executed by a secondary network-connected resource (not pictured) that is either managed centrally or through distributed means. At step 242, provider 259 can review the proposed agreement and generate and communicate to app service 255, a governing contract to control the access by UE app 256 to the resources of the network slice.

In the one or more embodiments depicted in FIG. 2D, a location condition can be a part of the control of the network slice implemented by provider 259. One way to implement a location condition is to set a location where the resources of the network slice can be utilized. For example, in step 243 UE app 256 can request a location token from node 258, and at step 244, node 258 can provide a location token that allows UE 257 to establish that it within a particular location boundary, e.g., within range of node 258. In one or more alternative embodiments, UE 257 can use alternative approaches to determining a location of UE 257, for later submission during validation processes discussed below. At step 244, the location token is received buy UE app 256 and, based on a request for slice membership 245 by app service 255, app service 255 is granted access to request permission to join the allocated slice.

In this example, at step 246, the app service 255 queries QBL 224 to confirm the location specified in the location token is valid for slice membership. Based on the location being valid, at block 247, QBL 224 can provide a contract hash to app service 255. Based on this contract hash, at step 248, app service 255 can create a slice membership transaction for validation by QBL 224 and, at step 249, validation by provider 259. Based on this validation, at step 250, provider can relay a request for service to node 258, requesting a promotion of UE 257 to membership in the allocated slice. Once UE 257 is promoted at step 251, UE app 256 can be allocated services required for the operation of app service 255.

In an example that illustrates different features described above, slice allocation can be beneficially performed for first responders in need of special privileges for emergency response. In an example, a proposed contract is provided by a UE identified as being used by a first responder. Example conditions requested can include, but are not limited to, allocated use of certain network ports for a secure connection to appropriate data sources (e.g., site and medical information), and high bandwidth for video streaming capability.

After receipt of the conditions above (i.e., represented by proposed contract data in the request), slice manager can evaluate the request and generate a governing contract for use by UE 257. For example, when considering the requested service conditions, policy manager can review basic conditions applicable to this type of requestor (i.e., a service level agreement (SLA) in place), past governing contracts to this type of customer (i.e., by a query of QBL), available network slice resources for the location of UE 257 (i.e., a network location token can be submitted as a part of the request), and other similar factors.

In this example, based on the above factors, the requested exclusive use of ports is granted, but the high bandwidth for video streaming capability is not permitted by the governing contract, e.g., because a triage of available resources for the location determines that less allocated resources for UE 257 can provide more needed resources for other responding parties. Based on this governing contract, resources associated with a network slice are granted to UE 257.

In another example, when first responder UE 257 leaves geographic proximity to an emergency event, this change can be detected (i.e., by the location services of network connectivity), and QBL 224 can be used to confirm the conditions of the governing contract are not violated by this new location. Because an anomalous condition (i.e., change of location) may be detected, different processes for provider 259 can be triggered, including either adapting the governing conditions to encompass the anomalous conditions or triggering the expulsion process for UE 257 from the allocated network slice.

FIG. 2E depicts a flow diagram 260 that illustrates connections and example of data exchanged between UE 257, node 258, QBL 224, and provider 259, that can facilitate the expulsion of UE app 256 from an allocated network slice, in accordance with one or more embodiments. For purposes of brevity, description of like elements and/or processes employed in other embodiments is omitted.

One or more embodiments can use the above-described features further for the definition and discovery of expulsion criteria for governing contract violations and anomalies in usage that can be indicative of violations. For example, in one or more embodiments, by monitoring slice activity across the network (e.g., by an anomaly detector), a provider can determine policy violations/anomalies for use in the expulsion from, or modification of, allocated network slices. It is important to note that, by utilizing QBLs, governing contracts, and the terms of expulsion from slices governed by these contracts, can be transparently published for external access, such that network slice membership can be verified with the application owner and justly terminated for violating policies, e.g., to promote confidence in the operation of the system.

For example, in an example depicted in FIG. 2E, at step 261, app service 255 of UE 257 can communicate a request for slice creation, including proposed contract data to provider 259 via node 258. As described above, proposed contract data can be reviewed, and selected terms can used to generate a governing contract for the requested connection, and at step 262, the governing contract can be appended in a ledger entry to QBL 224. At step 263, the entry can be validated (e.g., by QBL 330), and at step 264, provider executes service requirements to request allocation of resources by node.

At step 265, node 258 can promote UE 257 to membership in the generated network slice. It should be appreciated that, as used herein, UEs and applications can be described as promoted to using resources allocated in a network slice, with promotion being used, by one or more embodiments to described upgrading the resources available to the applications as compared to non-allocated resources.

In one approach used by one or more embodiments to maintain service levels allocated to a network slice (e.g., low-latency, high-bandwidth), key performance indicators (KPIs) can be measured and reported at different points in the delivery of resources. For example, at step 266, a tower providing wireless connectivity to UE 257 (e.g., node 258) can collect KPIs associated with allocated resources. Returning to the first responder allocations described above, for the network slice assigned to the first responder UE 257, KPIs associated with port exclusivity, bandwidth and other measurements can be collected and relayed to provider 259. In addition to providing data to facilitate the maintaining of the service levels of the network slice, the KPIs collected by different components can be used to detect anomalous behavior, e.g., activity by UE app 256 that potentially violates the terms of the governing contract.

At step 267, one or more embodiments can assess the collected KPIs by reading conditions stored in QBL 224, and if activity outside of the activity authorized by the governing contact is detected, at step 269 an app service penalty can be assessed on UE 257. In addition, at step 268, the detected violation can be communicated to provider 259, and an assessment of the violation can be made at provider 259, along with potential remedies, e.g., expulsion from the network slice or, in an opposite approach, upgrading the terms of the governing contract to encompass the detected behavior. In the example depicted in FIG. 2E, at step 270, provider 259 expels UE 257 for violating the terms of the governing contract, but alternative approaches are described below.

At step 271, node 258 signals UE that it is expelled from slice. At step 272, UE 257 signals UE app 256 that it is expelled from slice. At step 273, UE app 256 signal app service 255 that it is expelled from slice. App services 255 can make decisions on slice expulsion such as accept expulsion or upgrade governing contract terms to encompass a new slice creation request.

Continuing with to the first responder example discussed above, in an example of aspects of the above-described expulsion analysis, UE 257 operated by first responders, attempts to turn on video feed for an on-site surgical operation, this being restricted by the example governing contract described above. Based on the execution of this video function by UE 257, node 258 can detect the high bandwidth requested for delivery of the requested video. In one or more embodiments, this KPI condition can be identified as an anomalous condition and communicated to QBL 224 for analysis and confirmation. Upon a determination that the request for video by UE 257 violates the terms of the governing contract, provider 259 can perform a range of functions, including reevaluating factors that led to the initial restriction (i.e., congestion from other priority devices), and after revaluation, determining to enable the video transfer, because the video bandwidth can be accommodated by the available resources. Alternatively, provider 259 can trigger an expulsion of UE 257 from the allocated slice as described in the previous example.

To avoid the expulsion described above (i.e., especially for first responders), one approach that can be implemented allows UEs 257 operated by first responders (or other priority uses) that have been assigned a lower level of priority (i.e., the prohibition of video streaming described above) to request a priority uplift. This uplift can be reviewed and approved by provider 259, as well as locally, by a first responder command post manager for the emergency. Once approved, the resources available to an allocated slice can be upgraded. In additional embodiments, the ability to request priority uplift can be made available upon entering a proximity to an emergency (i.e., from 1-50 miles, 1.6-80 km), thus enabling the allocation of resources to begin before arriving at an emergency location. In an alternative embodiment, in some circumstances priority uplift could be automated and not require command post manager approval (automation could be based on location, priority, etc.).

In another example of monitoring, analysis, and expulsion, in one or more embodiments, unmanned aerial vehicles (UAVs) and other vehicles, as noted above, can require ultra-low latency for effective operation. In addition, these systems, also having operating systems, applications and media, can periodically require system updates. In one or more embodiments, as a part of a governing contract, terms can be included that recognize that the timing of update downloads can be significant for the operation of the vehicles, e.g., downloading large blocks while controlling a vehicle can interfere with the required low-latency operation of the vehicles.

While for purposes of simplicity of explanation, the respective processes are shown and described as a series of blocks in FIGS. 2D and 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

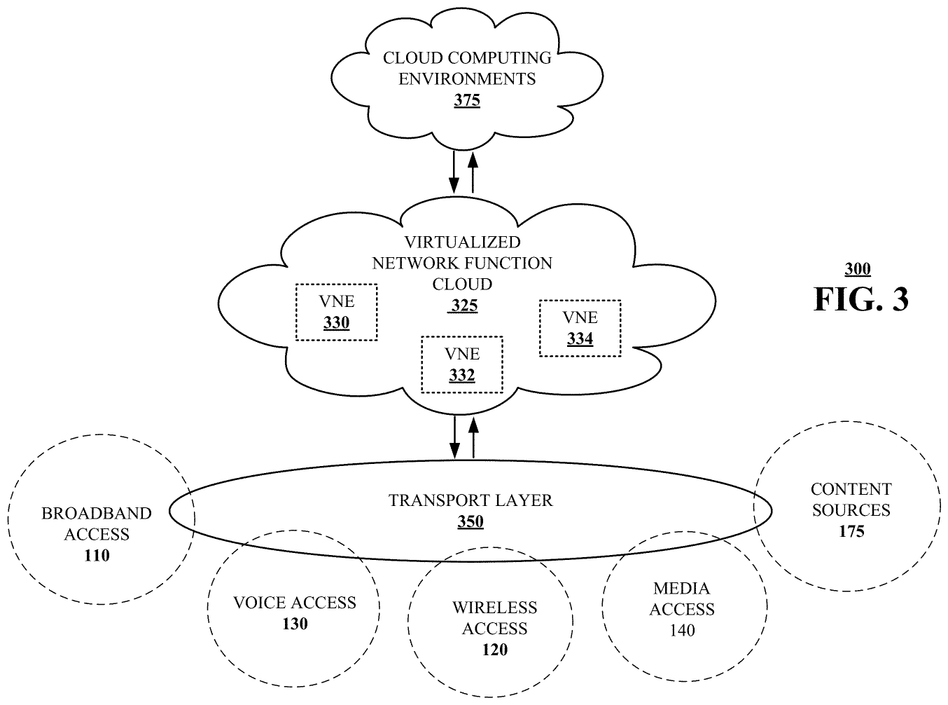

Referring now to FIG. 3, a block diagram 300 is shown illustrating an example, non-limiting embodiment of a virtualized communication network in accordance with various aspects described herein. A virtualized communication network is presented that can be used to implement some or all of the subsystems and functions of system 100, the subsystems and functions of system 220, and methods 240, 260 presented in FIGS. 1, 2B, 2C, 2D and 2E. For example, virtualized communication network 300 can facilitate in whole or in part receiving proposed contract data for access to resources of a network slice, storing governing contract data in a quantum blockchain ledger, scheduling use of the resources of the network slice for the application based on the governing contract data, detecting a condition of the access that is not encompassed by the governing contract, and terminating access to network slice resources.

A cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across several servers—each of which adds a portion of the capability, and which creates an overall elastic function with higher availability than its former monolithic version. These virtual network elements 330, 332, 334, etc. can be instantiated and managed using an orchestration approach like those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. Network workloads may have applications distributed across the virtualized network function cloud 325 and cloud computing environment 375 and in the commercial cloud or might simply orchestrate workloads supported entirely in NFV infrastructure from these third-party locations.

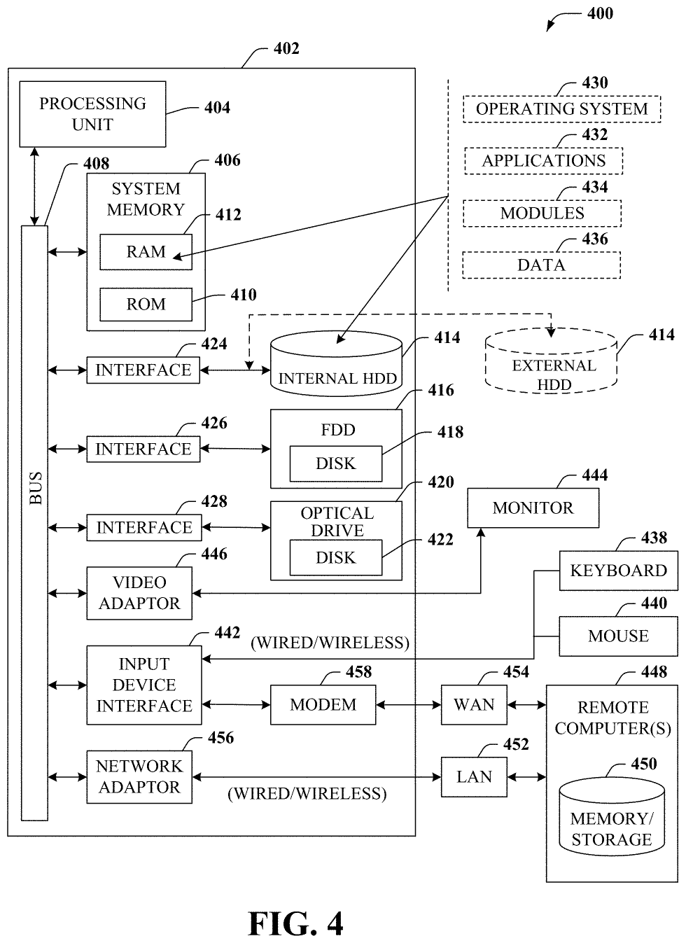

Turning now to FIG. 4, there is illustrated a block diagram of a computing environment in accordance with various aspects described herein. To provide additional context for various embodiments of the embodiments described herein, FIG. 4 and the following discussion are intended to provide a brief, general description of a suitable computing environment 400 in which the various embodiments of the subject disclosure can be implemented. Computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part receiving proposed contract data for access to resources of a network slice, storing governing contract data in a quantum blockchain ledger, scheduling use of the resources of the network slice for the application based on the governing contract data, detecting a condition of the access that is not encompassed by the governing contract, and terminating access to network slice resources.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, radio frequency (RF), infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

Several program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology like that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance like the basic 10BaseT wired Ethernet networks used in many offices.

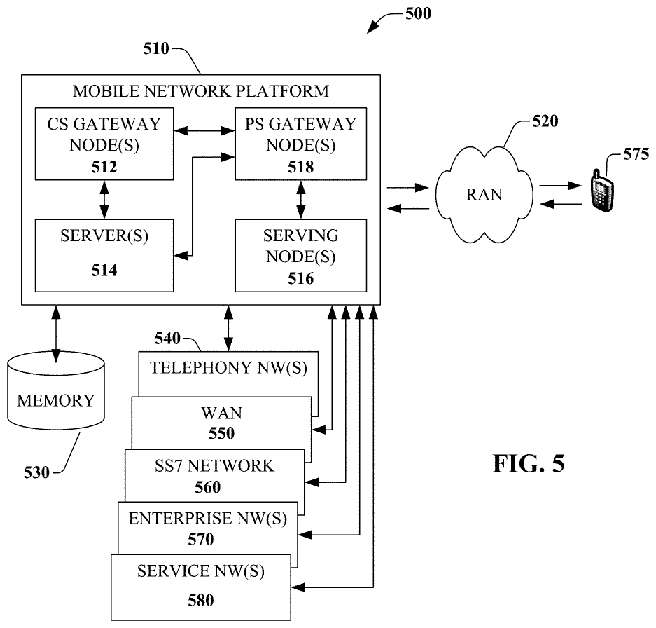

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part receiving proposed contract data for access to resources of a network (network slice, bandwidth, etc.), storing governing contract data in a quantum blockchain ledger, scheduling use of the resources of the network (network slice, bandwidth, etc.) for the application based on the governing contract data, detecting a condition of the access that is not encompassed by the governing contract, and terminating access to network resources (network slice, bandwidth, etc.). In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format) such flows. Such application(s) can comprise add-on features to standard services (for example, provisioning, billing, customer support) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

To provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

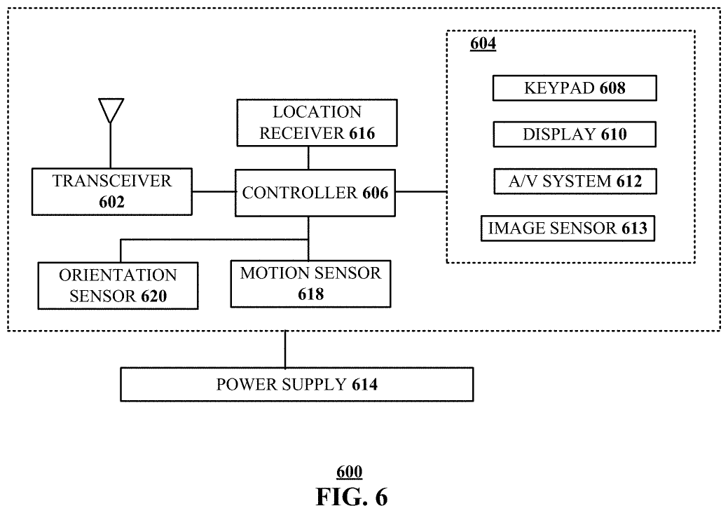

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part receiving proposed contract data for access to resources of a network slice, storing governing contract data in a quantum blockchain ledger, scheduling use of the resources of the network slice for the application based on the governing contract data, detecting a condition of the access that is not encompassed by the governing contract, and terminating access to network slice resources.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving proposed contract data representative of a proposed contract for access by an application of a user equipment to resources of a network slice usable for the access by the application;
based on the proposed contract data, storing governing contract data representative of a governing contract in a quantum blockchain ledger, wherein the storing the governing contract data comprises facilitating an appending of an information block corresponding to the governing contract data to the quantum blockchain ledger, and wherein the governing contract is selected to control the access by the application to the resources of the network slice;
scheduling use of the resources of the network slice for the application based on the governing contract data;
detecting a condition of the access that is not encompassed by the governing contract, resulting in a detected condition; and
based on the detected condition, terminating the access to the resources of the network slice by the application.

2. The device of claim 1, wherein the processing system comprises one or more quantum processors.

3. The device of claim 1, wherein the processing system comprises one or more quantum or hybrid quantum-classical processors.

4. The device of claim 1, wherein the resources of the network slice comprise a plurality of end-to-end quantum and hybrid quantum-classical networked application resources to implement quantum artificial intelligence (QAI) and/or quantum machine learning (QML) services.

5. The device of claim 4, wherein the QAI/QML services are implemented across a plurality of time, space, and frequency domains.

6. The device of claim 1, wherein the resources of the network slice comprise application programs, application programming interfaces (APIs), application servers, security servers, data repositories/lakes, routers, switches, load balancers, links, or a combination thereof.

7. The device of claim 1, wherein the operations further comprise verifying an owner of the resources of the network slice using a quantum digital signature.

8. The device of claim 7, wherein the quantum digital signature uses a public quantum-bit key with a private classical bit string or a private quantum bit string.

9. The device of claim 1, wherein the operations further comprise managing spectrum encryption and coding schemes to enhance security of the resources of the network slice.

10. The device of claim 1, wherein the condition of the access comprises a location condition.

11. A non-transitory, machine-readable medium, comprising executable instructions that, when executed by a processing system including a quantum processor or a hybrid quantum-classical processor, facilitate performance of operations, the operations comprising:
receiving proposed contract data representative of a proposed contract for access by an application of a user equipment to resources of a network slice usable for the access by the application;
based on the proposed contract data, storing governing contract data representative of a governing contract in a quantum blockchain ledger, wherein the storing the governing contract data comprises facilitating an appending of an information block corresponding to the governing contract data to the quantum blockchain ledger, and wherein the governing contract is selected to control the access by the application to the resources of the network slice;
scheduling use of the resources of the network slice for the application based on the governing contract data;
detecting a condition of the access that is not encompassed by the governing contract, resulting in a detected condition; and
based on the detected condition, terminating the access to the resources of the network slice by the application.

12. The non-transitory, machine-readable medium of claim 11, wherein the resources of the network slice comprise a plurality of end-to-end quantum and hybrid quantum-classical networked application resources to implement quantum artificial intelligence (QAI) and/or quantum machine learning (QML) services.

13. The non-transitory, machine-readable medium of claim 12, wherein the QAI/QML services are implemented across a plurality of time, space, and frequency domains.

14. The non-transitory, machine-readable medium of claim 11, wherein the resources of the network slice comprise application programs, application programming interfaces (APIs), application servers, security servers, data repositories/lakes, routers, switches, load balancers, links, or a combination thereof.

15. The non-transitory, machine-readable medium of claim 11, wherein the operations further comprise verifying an owner of the resources of the network slice using a quantum digital signature.

16. The non-transitory, machine-readable medium of claim 15, wherein the quantum digital signature uses a public quantum-bit key with a private classical bit string or a private quantum bit string.

17. The non-transitory, machine-readable medium of claim 11, wherein the operations further comprise managing spectrum encryption and coding schemes to enhance security of the resources of the network slice.

18. The non-transitory, machine-readable medium of claim 11, wherein the condition of the access comprises a location condition.

19. A method, comprising:
receiving, by a processing system including a quantum processor or a hybrid quantum-classical processor, proposed contract data representative of a proposed contract for access by an application of a user equipment to resources of a network slice usable for the access by the application;
based on the proposed contract data, storing, by the processing system, governing contract data representative of a governing contract in a quantum blockchain ledger, wherein the storing the governing contract data comprises facilitating an appending of an information block corresponding to the governing contract data to the quantum blockchain ledger, and wherein the governing contract is selected to control the access by the application to the resources of the network slice;
detecting, by the processing system, a condition of the access that is not encompassed by the governing contract, resulting in a detected condition; and
based on the detected condition, terminating, by the processing system, the access to the resources of the network slice by the application.

20. The method of claim 19, wherein the application schedules use of the resources of the network slice based on the governing contract data.
